(19) United States
(12) Patent Application Publication
(10) Pub. No.: US 2025/0319951 A1
(43) Pub. Date: Oct. 16, 2025

(54) TOTAL SERVO DRIVE IRT POS-SYNC AND LOAD SELF-ADAPTIVE JACK-UP COOPERATIVE CONTROL SYSTEM

(71) Applicant: Shanghai Maritime University, Shanghai (CN)

(72) Inventors: Hejun LIU, Shanghai (CN); Guichen ZHANG, Shanghai (CN); Qili WU, Shanghai (CN)

(21) Appl. No.: 18/963,808

(22) Filed: Nov. 29, 2024

(30) Foreign Application Priority Data
Apr. 11, 2024 (CN) 202410431716.0

(51) Int. Cl. B63B 39/00

(52) U.S. Cl. CPC B63B 39/00

(57) ABSTRACT

Disclosed is a total servo drive IRT pos-sync and load self-adaptive jack-up cooperative control system, belonging to the field of marine engineering equipment. The total servo drive IRT pos-sync and load self-adaptive jack-up cooperative control system includes a HMI, a main controller, a tilt angle sensor, a leg position calculator and a series of control modules of each leg; where the jack-up, the tilt angle sensor, the main controller and the leg position calculator are sequentially connected; the main controller is further connected to the HMI for data exchange; and each leg corresponds to a series of control module and is connected to the leg position calculator. According to the present disclosure, double layer virtual master axis IRT pos-sync with dynamic redundant load self-adaptive fault-tolerant strategy for single leg multi-motors cooperative control are implemented.

### TECHNICAL FIELD

The present disclosure relates to the field of marine engineering equipment, and in particular to a total servo drive IRT (Isochronous Real Time) pos-sync (position synchronization) and LSA (Load Self-Adaptive) jack-up cooperative control system.

### BACKGROUND

Jack-up offshore platform (jack-up) is one of the key mobile equipment for offshore oil and gas exploitation, which is mainly composed of a hull, legs, jacking system, etc. Modern jack-ups typically consist of a buoyant triangular platform supported by three independent triangular truss legs, each leg is composed of three chords, two racks are oppositely laid on two sides of each chord, a set of pinions are installed on each rack in an engagement mode. During lift up and down operations, multi-motors (a set of coupled motors) on each leg cooperatively drive pinions to move, so as to drive the jack-up lift up and down. Therefore, auto cooperative control of the jacking system is one of the key technologies for jack-up, since its control performance directly determine the stability, security and reliability of the entire platform.

The main disadvantages of current jack-up control system are as following:

(1) Current jack-up control system uses normal non-servo induction motor to drive the jack-up mechanism, the static torque and starting torque at low speed is small, but the request of static and starting torque is usually big because it first need to overcome the static friction at start period, so it may cause an unreliable and unsmooth starting.

(2) There is no direct position closed-loop control mode for non-servo induction motor, it is difficult to achieve a high position accuracy control, especially at high speed. For jack-up multi-motors control, there is no stable and reliable pos-sync cooperative control mechanism, it may cause a big position deviation between different chords on the leg during moving, and cause a serious security problem.

(3) For jack-up multi-motors control, current jack-up control system do not take load balance into consideration. However, the fact is that the leg of jack-up and racks installed on the leg may get some structure distortion under the influence of complex work environment at sea, this may cause a load unbalance over different pinion. So, the load torque of each jacking motor may have a big difference at the same time, and the worst situation is that the output torque direction of some motors is completely opposite, thus the negative torque motor work against the positive torque motor rather than work jointly with each other. In this case, the total drive force of the jacking system decreased and some jacking motors may overload, the continuous and stable operation performance of the jack-up is seriously restricted.

(4) During jack-up moving, if one chord or jacking motor failed, the entire jacking system can not work, since there is no dynamic fault-tolerant design for the jack-up control system.

### SUMMARY

In order to solve the problems in the prior part, the present disclosure provides a total servo drive IRT pos-sync and load self-adaptive jack-up cooperative control system, in which all jacking motors use servo motor and direct position close-loop control mode, high position accuracy control can be achieved. For each single leg multi-motors control, IRT pos-sync mode with double layer virtual master axis dynamic redundant fault-tolerant control strategy is performed, thus on the one hand, high accuracy position synchronization of multi-motors can be achieved, on the other hand double-layer dynamic redundant fault-tolerant protection can be implemented, security and reliability of the jacking system can be obviously increased. What's more, all jacking motors on the leg performs a load self-adaptive control, by which all time load balance for multi-motors on the leg can be realized, thus the fault-tolerant and robust performance of the jacking system can also be significantly improved. In order to achieve this purpose, the present disclosure provides a total servo drive IRT pos-sync and load self-adaptive jack-up cooperative control system. The total servo drive IRT pos-sync and load self-adaptive jack-up cooperative control system includes:

The present disclosure has the following beneficial effects:

(1) Total servo drive and servo motors for jack-up control system with high static torque, staring torque and motion dynamics, more starting drive force to make jack-up starting and moving much more smooth and reliable.

(2) Direct position close-loop control mode for each jacking motors, high position accuracy can be achieved.

(3) For single leg multi-motors cooperative control, IRT pos-sync mechanism is performed, high accuracy position synchronization can be achieved.

(4) Double layer virtual master axis dynamic redundant fault-tolerant control strategy is implemented, when a chord or motor failed during jack-up moving, failed component can be auto bypassed and the master and slave object in the system can be dynamically specified, Jack-up can continue moving rather than stopped. The flexibility, reliability and fault-tolerant capacity of the Jack-up control system can be obviously increased.

(5) To solve the local overload or load unbalance problem, a load self-adaptive control based on IRT pos-sync is performed for each motor on the leg, all time load balance for multi-motors on the leg can be achieved, fault-tolerant capacity and robust performance of the Jack-up control can also be significantly improved.

### BRIEF DESCRIPTION OF THE DRAWINGS

FIG. 1 is a block diagram of a total servo drive IRT pos-sync and load self-adaptive jack-up cooperative control system according to an embodiment of the present disclosure.

FIG. 2 is a working principles diagram of IRT pos-sync control for master and slave axis according to an embodiment of the present disclosure.

FIG. 3 is a diagram of double layer virtual master axis IRT pos-sync with dynamic redundant fault-tolerant control strategy for single jack-up leg according to an embodiment of the present disclosure.

FIG. 4 is a principle diagram of load self-adaptive control based on IRT pos-sync for single jack-up chord according to an embodiment of the present disclosure.

FIG. 5 is a principle diagram of load self-adaptive control based on IRT pos-sync for single jack-up leg according to an embodiment of the present disclosure.

FIG. 6 is a main implement flow diagram for total servo drive IRT pos-sync and load self-adaptive jack-up cooperative control system according to an embodiment of the present disclosure.

### DETAILED DESCRIPTION OF THE EMBODIMENTS

The present disclosure will be further described below with reference to accompanying drawings and in conjunction with embodiments.

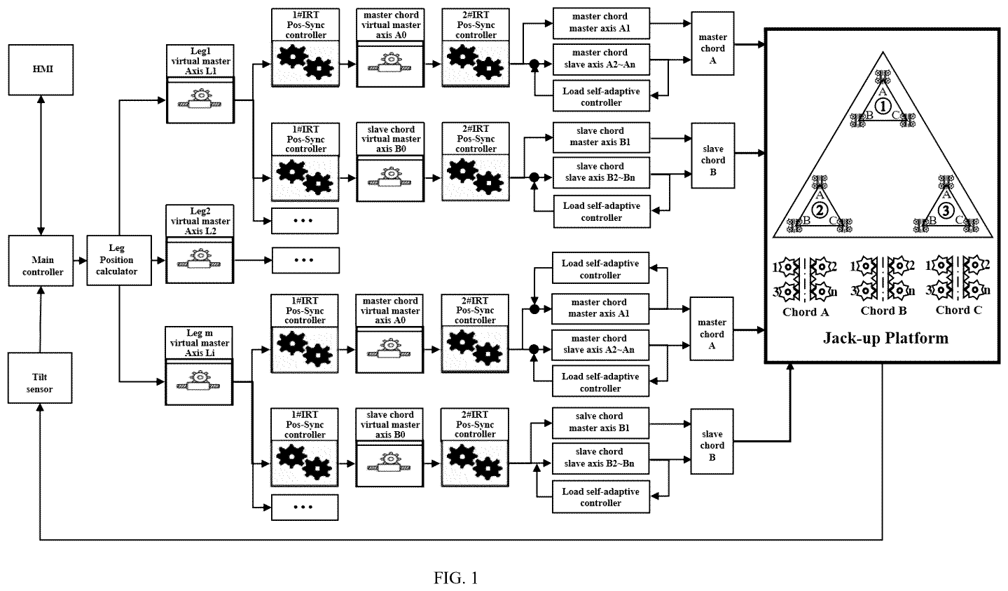

As shown in FIG. 1, the embodiment of the present disclosure provides a total servo drive IRT pos-sync and load self-adaptive jack-up cooperative control system. Double layer virtual master axis IRT pos-sync with dynamic redundant load self-adaptive fault-tolerant control strategy is performed. High accuracy multi-motors pos-sync, security and reliability can be achieved. In addition, load balance of multi-motors on single leg can be dynamically self-adaptive adjusted in real time during jack-up movements. Thus, a smooth and continuous jacking up and down operation can be realized.

Composition of the system and functions are as follows:

The system includes a jack-up provided with legs, a HMI, a main controller, a tilt angle sensor, a leg position calculator and series of control modules for each leg. The jack-up, the tilt angle sensor, the main controller and the leg position calculator are sequentially connected. The main controller is further connected to the HMI for information exchange.

Jack-up platform includes a plurality of truss legs (typically three). Each leg corresponds to one control module and is connected to the leg position calculator, the leg position control performed by IRT position synchronization mode with double layer virtual master axis redundant control strategy, the set position the leg virtual master come from the output of the leg position calculator. During jacking movements, a load self-adaptive control for multi jacking motors on the leg is implemented.

Each leg is composed of m chords (m=3 in FIG. 1), one chord is specified as master chord and the other chords are slave chord. Each chord installed a rack, each rack match with n pinions to make up multiple rack and pinion drive units, and each pinion is driven by a servo axis. Each axis includes one servo motor and one servo drive. Multi-motors are work cooperatively to drive the jack-up move up and down. Each servo motor has a high accuracy encoder which can measure the motor's actual position and speed in real time to perform a direct position close loop control. In this jacking system, all motors are use servo motors which have a high static torque and low-speed output torque capacity, thus can drive the jack-up more stable in starting or stop period.

The HMI (human machine interface) is configured to connect to the main controller to perform machine status monitoring, parameter setting and related operations.

The tilt angle sensor measures the tilt angle of the jack-up in real-time and feedback this data to the main controller for position control of each leg.

The main controller performs both motion control and logic control, detect the real-time tilt angle of the jack-up, receives operation commands and set data from HMI and send corresponding data to a subsequent module.

The leg position calculator receives the detected tilt angle and the target position set value of the leg from main controller, calculate set position of each leg in real time and send it to the leg virtual master axis.

The control module of each leg performs a double-layer virtual master axis redundant fault-tolerant control strategy based on IRT pos-sync control. The control module includes a leg virtual master axis module, first layer IRT pos-sync controller module (1# IRT pos-sync controller), a chord virtual master axis module, second layer IRT pos-sync controller module (2# IRT pos-sync controller), a servo axis control module with load self-adaptive controller module, a chord rack and pinion drive unit module, which are sequentially connected.

Each leg design one leg virtual master axis, each chord design one chord virtual master axis. Except to have a real motor and drive, the virtual axis can perform a direct position loop control just the same as real axis. The leg virtual master axis module performs a position control on the virtual master axis of the leg by taking a target position set value output by the leg position calculator.

Each chord virtual master axis in the same leg can realize a pos-sync with its corresponding leg virtual master axis by 1# IRT pos-sync controller.

Each axis in the same chord can realize a pos-sync with its corresponding chord virtual master axis by 2# IRT pos-sync controller.

For each single chord, one axis is specified as master axis and the other axes are slave axis. Each slave axis is connected to a LSA controller to realize the load balance in the single chord. Each master axis in the slave chord is also connected to a LSA controller to realize the load balance in the entire leg.

The LSA controller can dynamically generate a compensation position value for slave axis according to the torque value of master and slave axis. The details are as following:

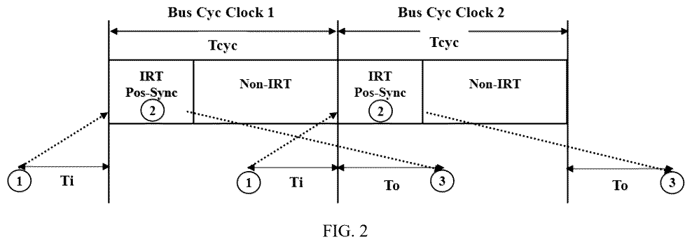

The IRT pos-sync working principles diagram of master and slave axis is shown in FIG. 2:

Each IRT pos-sync controller is designed based on direct position loop control and isochronous real time bus communication. The IRT control mode obtain the measured values and process data in a fixed system cycle, and process the signal and output synchronously in the process. Based on IRT control mode, the machine time cycle, communication cycle and program cycle can be synchronized, and the application of isochronous synchronization can be realized, and the control accuracy can be greatly improved. IRT control mode can ensure that the process response time is completely consistent and has accurate and reliable repeatability. Stations in the synchronization domain process cycles and input and output signals synchronously with constant bus time. Therefore, IRT pos-sync control mode can significantly improve the certainty of control instructions, reduce possible fluctuations in process response time, and realize a high accuracy pos-sync control.

In IRT control system, the bus communication time is divided into many constant small time slices, called bus cycle clock (Tcyc). In each bus cycle clock, IRT task is first to be processed and should be finished in current bus clock, in the left time the non-IRT task will be processed and can be processed in next bus clock if not finish in current bus clock.

The main process of IRT pos-sync between master and slave axis are as following:

Ti (data input time) before every bus cycle clock, measured both master and slave axis actual position from input area.

At every start of bus cycle clock, IRT pos-sync program is processed, a position setpoint will be calculated to make the slave axis position synchronized with the master axis rigidly.

To (data output time) after every bus cycle clock, the calculated position setpoint will be send out to slave axis for executing.

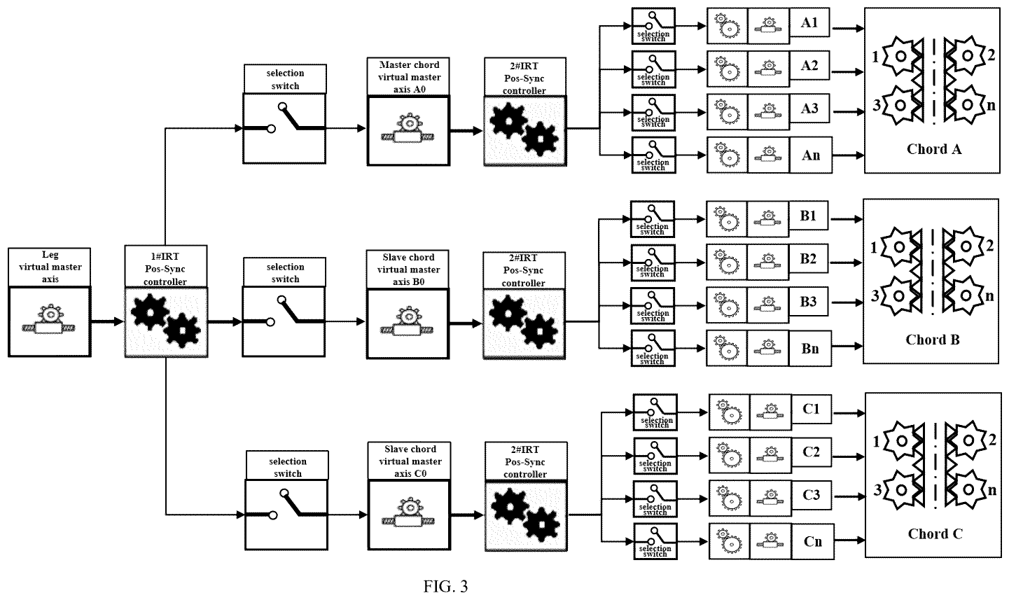

As shown in FIG. 3, a double layer virtual master axis IRT pos-sync with dynamic redundant fault-tolerant control is performed for each single leg is performed to avoid an abnormal stop caused by chord or motor failure when jack-up is moving.

Each leg is composed of a plurality of chords, and each chord is driven synchronously by multi servo axes via the rack and pinion drives. For example, the chord A is driven by the multi-axes A1-An. For a typically triangular leg truss structure, each leg is composed of three chords.

Each chord set a virtual master axis (A0/B0/C0), all servo axis on this chord performed a position synchronization with the chord virtual master via 2# IRT pos-sync controller. Each leg set a virtual master, all chord virtual master on this leg performed a position synchronization with the leg virtual master via 1# IRT pos-sync controller.

After above-mentioned double layer IRT pos-sync, all servo motors on one leg can cooperatively worked together by synchronized with the position of the same leg virtual master. all servo motors on the same leg have the same position setpoint and each of them performed a position close loop control, thus a high accuracy position synchronization control of multi-motors on the single leg can be achieved.

Double layer dynamical redundant fault-tolerant is also performed for each leg to make the jack-up more security and reliable, the details are as following:

Each chord virtual axis in one leg has a separate selection switch, and via this switch, a position synchronization relation between the chord virtual master axis and the leg virtual master axis can be dynamically established by 1# IRT pos-sync controller module. As the same, each servo axis (motor) in one chord has a separate selection switch, and via this switch, a position synchronization relation between the servo axis and the chord virtual master axis can be dynamically established by the 2# IRT pos-sync controller module.

If one chord failed during jack-up moving, the failed chord virtual master axis will synchronous off from the leg virtual master axis immediately and automatically bypassed. If the master chord of the leg failed, the sequential second chord will dynamically auto succeed as the master chord.

If one servo axis failed during jack-up moving, the failed servo motor will synchronize off from the chord virtual master axis immediately and automatic bypassed. If the master axis of the chord failed, the sequential second motor will dynamically auto succeed as the master motor.

By this way, a double layer dynamically redundant fault-tolerant control mechanism is established, and the jack-up can continue moving rather than stopped caused by the failed unit. What's more, double layer master axis can be dynamically auto changed when current master axis failed during moving, the load self-adaptive can also continue work. Thus, the security and reliability of the jack-up cooperative control system are significantly improved.

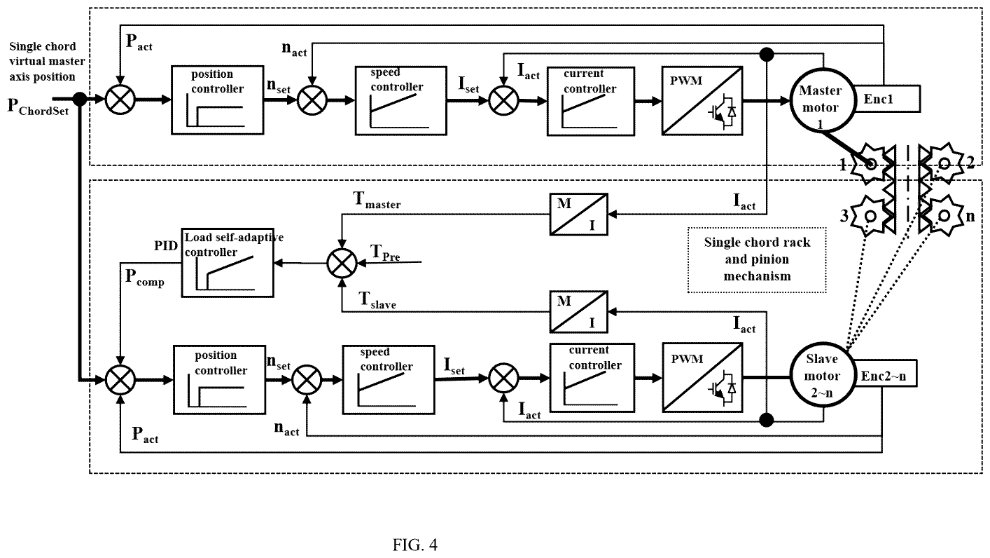

The principle of LSA control based on IRT pos-sync for single chord is shown in FIG. 4. Each chord is driven by 1-n servo motors, one motor set as the master motor (motor 1 in FIG. 4), the left motors on the same chord are slave motors. All motors are servo motor with encoder.

Each motor performs a position controller, a speed controller and a current controller, they are sequential connected.

Through the position controller, high accuracy position closed-loop control can be achieved according to the position set value from chord virtual master axis and real-time position feedback by the encoder.

According to speed set value computed by the position controller and the real-time actual speed feedback by the motor encoder, high dynamic speed closed-loop control can also be implemented. A current controller lay out between the speed controller and PWM (Pulse Width Modulation) module to realize a current loop control.

The current of master servo motor is sampled in real time and converted to master torque value (Tₘₐₛₜₑᵣ) via M/I module.

The current of slave servo motor is also sampled in real time and converted to slave torque value (Tₛₗₐᵥₑ) via M/I module.

Each slave motor on the chord will activate its own LSA controller. Both Tₘₐₛₜₑᵣ and Tₛₗₐᵥₑ are the input of the LSA controller, and the position compensation (P_{comp}) value to the slave motor is the output of the controller. If the deviation of Tₘₐₛₜₑᵣ and Tₛₗₐᵥₑ greater the setting tolerance, the LSA controller will output a position compensation value to slave motor to reduce the deviation until the deviation is not big than the tolerance according to provided algorithm. P_{comp} executed by the slave motor will then narrow the torque deviation, thus a load (torque) balance can be realized in the master and slave axis on the same chord.

Since the IRT pos-sync with the chord virtual master axis, all motors on one chord will have the same position setpoint (P_{chordset}) from the chord virtual master as the main position setpoint. P_{chordset} added with P_{comp} to form the total position setpoint of each slave motors. Since the driven pinion and the rack unit for both master and slave motor on the chord will not have a big difference in size, meanwhile the LSA controller processed in very fast IRT cycle clock, compare to P_{chordset}, P_{comp} is usually small, so that the position of multi-motors on the chord is approximate the same. By this way, a high dynamic torque balance between multi-motors on the single chord based on IRT pos-sync is achieved.

The LSA controller can use a PID controller, and the parameters of the controller can be optimized and self-tunning through an intelligent algorithm such as back propagation-radial basis function (BP-RBF) neural network, genetic algorithm, etc.

To activate the anti-backlash function in the chord, it need to set an anti-backlash preload torque (Tₚᵣₑ) value in advance, usually small. The sum value of the Tₘₐₛₜₑᵣ and Tₚᵣₑ is taken as the target set value of LSA controller for the slave motor. Tₛₗₐᵥₑ is also input to the controller as an feedback value, and the output of the controller is P_{comp} to each slave motor. By this way, this small Tₚᵣₑ torque gap between master and slave motors will make each driven pinion to have a close contact to the rack tooth, so that the backlash in the drive unit can be eliminated and the movement can be more smoothly.

A dead band deviation tolerance can be set for the LSA controller to avoid the unstable caused by too frequent adjustment.

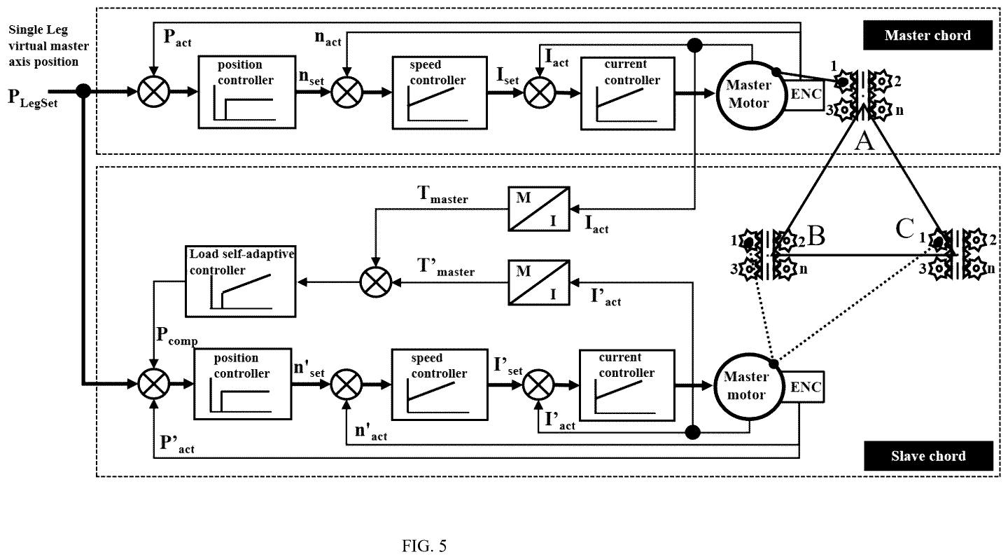

The principle of LSA control based on IRT pos-sync for single leg is shown in FIG. 5.

Each leg is composed of a plurality of chords, for a typically triangular leg truss structure, each leg is composed of three chords.

Each chord slave motor performs the same as descripted in FIG. 4.

As mentioned in FIG. 3, through double layer IRT pos-sync, each chord on the same leg will have the same position setpoint (P_{legset}) as the main position.

As LSA control of different chord on one leg, it takes the torque value of master motor on master chord (Tₘₐₛₜₑᵣ) as target value and compare it with the torque value of master motor on slave chord (T′ₘₐₛₜₑᵣ), if the torque deviation greater than the setting tolerance, the controller will output a position compensation value for master motor on slave chord, which will then narrow the torque gap deviation, thus a load (torque) balance can be realized between different chord on the same leg.

Through above two layer of load self-adaptive control, both load balance of master and slave motors on the same chord and load balance of master motors on different chord were achieved, so that all drive motors load balance on the single leg were realized. The local overload problem caused by complex working condition can be solved, the fault-tolerant ability of the jack-up is improved.

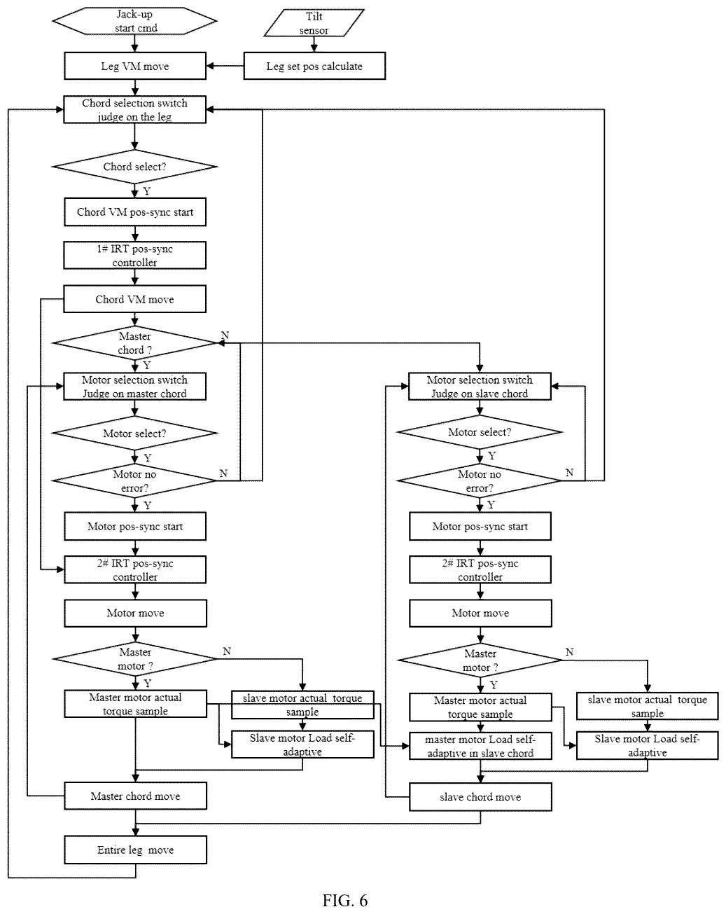

The main implement flow diagram for total servo drive IRT pos-sync and load self-adaptive jack-up cooperative control system is shown on FIG. 6, and including:

The leg position calculator calculates the position setpoint according to the measured tilt angle sensor and setting data in real time.

Once received the jack-up start command, each leg virtual master axis (VM) start to perform a position control according to the position setpoint from the leg position calculator.

The first layer IRT pos-sync selection switch for each chord on the leg will dynamically be judged according to the chord failure error message and activation setting data by HMI in real time. Meanwhile, the master and slave chord are dynamically specified. If one chord failed, its pos-sync selection switch will off. If the master chord of the leg failed, the sequential second chord will dynamically be specified as the master chord.

If the chord is selected (chord IRT pos-sync selection switch on), the chord virtual master axis will start perform a pos-sync with the leg VM via 1# IRT pos-sync controller. Thus, all selected chord VM on the single leg can move follow the leg VM.

For both master and slave chord, the second layer IRT pos-sync selection switch for each motor on the chord will dynamically be judged according to the motor failure error message and activation setting data by HMI in real time. Meanwhile, the master motor and slave motors are dynamically specified. If one motor failed, its IRT pos-sync selection switch will off. If the master motor on the chord failed, the sequential second chord will dynamically be specified as the master motor. If all motors on the chord failed, the entire chord is failed, then the chord pos-sync selection switch will off.

If the motor is selected (motor IRT pos-sync selection switch on) and no failure error exist, the motor will start perform a pos-sync with the chord VM via 2# IRT pos-sync controller. Thus, all selected motor on the single chord can move follow the chord VM.

For each slave motor on the same chord, a load self-adaptive control will be performed according to the real time sampled master motor torque value and slave motor torque value.

For each master motor on the slave chord, a load self-adaptive control will be performed according to the real time sampled master motor torque value on master chord and slave motor torque value on the slave chord.

Through the above process, a total servo IRT pos-sync and load self-adaptive control method of the jack-up is implemented, and the entire jack-up can raise up and down much more smoothly, security and reliable.

It should be noted that the above embodiments are merely intended to describe the technical solutions of the present disclosure rather than limiting same. Although the present disclosure is described in detail with reference to the preferred embodiments, those skilled in the art should understand that modifications or equivalent replacements can be made to the technical solutions of the present disclosure without departing from the spirit and scope of the technical solutions of the present disclosure, and should fall within the scope of the claims of the present disclosure.

What is claimed is:

1. A total servo drive IRT pos-sync and LSA (load self-adaptive) jack-up cooperative control system, comprises a jack-up provided with legs, and further comprising a HMI, a main controller, a tilt angle sensor, a leg position calculator and a series control module of each leg; where in the jack-up, the tilt angle sensor, the main controller and the leg position calculator are sequentially connected; the main controller is further connected to the HMI for information exchange; and the HMI is configured for a human-machine interaction interface of the entire system, so as to implement status monitoring, parameter setting and a related operation by the control system; the tilt angle sensor measures a real-time tilt angle of the jack-up and send it to the main controller; the main controller samples the real-time tilt angle measured of the jack-up, and send it to the leg position calculator; the calculator calculate out a target position setpoint of each leg and send them to the leg control modules; each leg corresponds to a series control module connected to the leg position calculator, and performed a double-layer virtual master axis IRT pos-sync with dynamic redundant fault-tolerant strategy for each leg multi-motors cooperative control.

2. The total servo drive IRT pos-sync and LSA (load self-adaptive) jack-up cooperative control system according to claim 1, wherein a series control module of each leg comprises a leg virtual master axis module, a 1# IRT pos-sync controller module, a chord virtual master axis module, a 2# IRT pos-sync controller module, a servo axis module, a load self-adaptive controller module and a rack and pinion drive unit that are sequentially connected; each leg comprises a plurality of chords, each chord installed a rack, each rack matched with multi-pinions to form a plurality of rack and pinion drive units, and each rack and pinion drive unit is driven by a servo axis; each leg set a leg virtual master axis, each chord set a chord virtual master axis; each leg virtual master axis module performs position control on the leg virtual master axis by taking the position setpoint output by the leg position calculator as the target position; 1# IRT pos-sync controller module comprises an IRT pos-sync controller designed for multi-chord virtual master axes perform an IRT position synchronization with corresponding leg virtual master axis; 2# IRT pos-sync controller module comprises an IRT pos-sync controller designed for multi-axes on the same chord perform an IRT position synchronization with corresponding chord virtual master axis; each servo axis comprises a servo drive and a servo motor to drive the pinion; a position controller, a speed controller module, a current controller module and a PWM module are sequential connected between chord virtual master and servo motor to perform a high accuracy close loop position control; each slave axis on the chord or master axis on slave chord configured a LSA controller to realize a dynamic load balance on the corresponding leg.

3. The total servo drive IRT pos-sync and LSA (load self-adaptive) jack-up cooperative control system according to claim 2, wherein the IRT pos-sync controller is designed based on direct position loop control and isochronous real time bus communication; the IRT system obtain the measured values and process data in a fixed system cycle, and process the signal and output synchronously in the process; the main process of IRT pos-sync between master and slave axis is:
Ti (data input time) before every bus cycle clock, measured both master and slave axis actual position from input area; at every start of bus cycle clock, IRT pos-sync program is processed, a position setpoint will be calculated to make the slave axis position synchronized with the master axis rigidly; To (data output time) after every bus cycle clock, the calculated position setpoint will be send out to slave axis for executing.

4. The total servo drive IRT pos-sync and LSA (load self-adaptive) jack-up cooperative control system according to claim 1, wherein double layer dynamical redundant fault-tolerant is performed for each leg and specified as following: each chord virtual master axis on one leg and each axis on one chord has an IRT pos-sync selection switch capable of being dynamically judged according to the corresponding error message and user set data, master chord and master axis are auto dynamically specified; each failed chord virtual master axis will auto synchronous off from the leg virtual master axis and bypassed; the sequential second chord dynamically auto succeeds as the master chord when master chord failed; each failed servo axis auto synchronous offs from the chord virtual master axis and bypassed; the sequential second axis dynamically auto succeeds as the master axis when master axis failed.

5. The total servo drive IRT pos-sync and LSA (load self-adaptive) jack-up cooperative control system according to claim 2, wherein the LSA is configured and specified as following:
each slave motor on the chord configured a LSA controller, each controller take both master torque value and slave as the input and output a position compensation value to the slave motor in real time to make a load balance of multi-motors on the same chord; an anti-backlash preload torque value is set in advance to activate the anti-backlash function in the chord; each master motor on the slave chord configured a LSA controller, each controller take the torque value of master motor on master chord and the torque value of master motor on slave chord as the input and output a position compensation value to the master motor on slave chord in real time to make a load balance of multi-chord on the same leg.

6. The total servo drive IRT pos-sync and LSA (load self-adaptive) jack-up cooperative control system according to claim 5, wherein the performed LSA controller uses a PID controller, the parameters of the controller are optimized and self-tunning through an intelligent algorithm such as back propagation-radial basis function (BP-RBF) neural network, genetic algorithm, etc.
